(19) United States
(12) Patent Application Publication
(10) Pub. No.: US 2019/0074101 A1
(43) Pub. Date: Mar. 7, 2019

(54) METHOD FOR MANUFACTURING ALUMINUM ALLOY BUS BAR, ALUMINUM ALLOY BUS BAR, AND ALUMINUM ALLOY MATERIAL FOR BUS BAR

(71) Applicant: UACJ Corporation, Tokyo (JP)

(72) Inventors: Keita FUKAWA, Tokyo (JP); Mineo ASANO, Tokyo (JP); Gaku TORIKAI, Tokyo (JP)

(21) Appl. No.: 16/182,811

(22) Filed: Nov. 7, 2018

Related U.S. Application Data
(62) Division of application No. 15/786,202, filed on Oct. 17, 2017.

(30) Foreign Application Priority Data
Oct. 18, 2016 (JP) 2016-204723
Jun. 7, 2017 (JP) 2017-112439

(51) Int. Cl. H01B 1/02; C22C 21/08; H01B 5/02; C22C 21/02; H01B 13/00; C22F 1/043; C22F 1/047

(52) U.S. Cl. CPC H01B 1/023; C22C 21/08; H01B 5/02; C22F 1/047; H01B 13/0036; C22F 1/043; C22C 21/02

(57) ABSTRACT

During edgewise bending that is carried out on an aluminum alloy bus bar made of an aluminum alloy rectangular wire, an edgewise bending portion is heated to a temperature between 100 and 250° C. inclusive, and within 5 minutes after the heating, edgewise bending is carried out. In the aluminum alloy bus bar, the ratio A/B of Vickers hardness A in a heated portion to Vickers hardness B in a non-heated portion is at least 0.8. If necessary, flatwise bending is further carried out on the aluminum alloy bus bar, forming the bus bar into a predetermined shape.

This application is a divisional of application Ser. No. 15/786,202, filed Oct. 17, 2017.

### FIELD

The present disclosure relates to a method for producing aluminum alloy bus bars, an aluminum alloy bus bar, and an aluminum alloy material for bus bars.

### BACKGROUND

As a conductive wiring material for power control units (PCUs) on transportation machinery including bullet trains, linear motor cars, hybrid cars, and electric cars, bus bars made of pure copper plates with superior conductivity and strength are conventionally used. In recent years, bus bars made of aluminum alloys have been taken into consideration since aluminum alloys are less expensive and have a lower specific gravity than copper.

However, producing an intricately-shaped bus bar by means of blanking with a press is problematic because a lot of blanking scrap is generated, resulting in reduced yields.

As a solution to such problem, a bus bar formed into a desired shape not by conventional press blanking but by edgewise bending (Patent Literature 1) is proposed. In addition, a method for forming a recess in an edgewise bending portion (Patent Literature 2) is proposed for the purpose of improving edgewise bending workability.

Patent Literature 1 International Publication No. WO 2012-117650

Patent Literature 2 Unexamined Japanese Patent Application Kokai Publication No. 2015-228476

### SUMMARY

When an aluminum alloy is used for a bus bar, the bus bar needs to have a larger cross-sectional area than a copper bus bar because an aluminum alloy has lower electrical conductivity than copper. To obtain a larger cross-sectional area, a wide bus bar may be needed for use because of restriction on the space containing the bus bar. However, when edgewise bending is being applied to such wide bus bar, cracks may occur on the outer periphery of an edgewise bending portion because of inferior bending workability of an aluminum alloy.

The present disclosure has been created in view of the foregoing circumstances, and a first objective of the disclosure is to provide a method for producing an aluminum alloy bus bar that has the strength needed for a bus bar and that provides high product yields by employing edgewise bending. In addition, the first objective includes providing an aluminum alloy bus bar produced by using such method for producing an aluminum alloy bus bar.

A second objective of the present disclosure is to provide an aluminum alloy material for bus bars that has the conductive performance needed for a bus bar and that provides high product yields by employing edgewise bending. In addition, the second objective includes providing a bus bar that includes such aluminum alloy material for bus bars and providing a method for producing the bus bar.

To achieve the above-described objective, a method for producing an aluminum alloy bus bar according to a first aspect of the present disclosure is

a method for producing an aluminum alloy bus bar that is formed in a predetermined shape by carrying out edgewise bending and, if necessary, flatwise bending on an aluminum alloy rectangular wire, the method including:

during the edgewise bending, heating a bending portion at a temperature between 100 and 250° C. inclusive and holding the bending portion, and then carrying out the edgewise bending.

In the foregoing method for producing the aluminum alloy bus bar,

a time period of the holding may be 5 minutes or less.

A material for the aluminum alloy rectangular wire may be a T6 thermal refined aluminum alloy material including chemical components of Mg: 0.3 to 0.9%, Si: 0.2 to 1.2%, Cu: 0.2% or less, and Fe: 0.5% or less, with a balance consisting of Al and inevitable impurities.

A bending speed in the edgewise bending may be 90°/second or less.

A portion to be fastened to another component may be at a temperature of 150° C. or lower during the heating.

To achieve the above-described objective, an aluminum alloy bus bar according to a second aspect of the present disclosure is

an aluminum alloy bus bar produced by using the foregoing method for producing the aluminum alloy bus bar,

wherein the ratio A/B of Vickers hardness A in a heated portion to Vickers hardness B in a non-heated portion is at least 0.8.

To achieve the above-described objective, an aluminum alloy material for a bus bar according to a third aspect of the present disclosure is

an aluminum alloy material for a bus bar, wherein the material includes a straight portion and edgewise bending is to be carried out on the material, the material including:

a recess formed in a portion corresponding to the inner periphery of a bending portion for the edgewise bending; and

a projection formed in a portion corresponding to the outer periphery of a bending portion for the edgewise bending.

The recess may be in an arc shape having a radius at least equal to an inner bending radius of an edgewise bending portion, and

a minimum distance between an edge of the recess and an edge of the projection may be at least equal to a width of the straight portion.

An area of the projection may be at least equal to an area of the recess.

The projection may include a plurality of individual projections.

The perimeter of an arc of the projection may be longer than the perimeter of an arc of the recess.

To achieve the above-described objective, a bus bar according to a fourth aspect of the present disclosure includes:

the foregoing aluminum alloy material for a bus bar.

To achieve the above-described objective, a method for producing a bus bar according to a fifth aspect of the present disclosure includes:

preparing a bus bar material that includes a straight portion and an edgewise bending portion being curved by a recess and a projection; and

carrying out edgewise bending on the edgewise bending portion, wherein the recess is on the inner side and the projection is on the outer side.

The foregoing method for producing the bus bar includes heating the bending portion to 100° C. or higher when edgewise bending is carried out, which can improve edgewise bending workability in the bending portion.

In addition, setting an upper limit of the heating temperature to 250° C. can avoid reducing the strength.

As described above, the present disclosure can achieve high product yields by improving edgewise bending workability and can provide bus bars having superior strength by preventing materials from softening.

The foregoing aluminum alloy material for bus bars is easy to carry out edgewise bending because a recess is disposed on the inner periphery of an edgewise bending portion in advance, thereby providing higher yields.

In addition, the foregoing aluminum alloy material for bus bars holds superior electrical conductivity after edgewise bending because a projection is disposed on the outer periphery of an edgewise bending portion in advance, which means, in spite of the recess disposed on the inner periphery of an edgewise bending portion, the cross-sectional area involving the projection and recess is approximately the same as that of a straight portion.

As described above, the present disclosure provides an aluminum alloy material for bus bars that has the conductive performance needed for a bus bar and that provides high product yields by employing edgewise bending. In addition, the disclosure provides a bus bar that includes the foregoing aluminum alloy material for bus bars and a method for producing such bus bar.

### BRIEF DESCRIPTION OF THE DRAWINGS

A more complete understanding of this application can be obtained when the following detailed description is considered in conjunction with the following drawings, in which:

FIG. 1 is a schematic diagram illustrating an aluminum alloy bus bar that underwent edgewise bending;

FIG. 2 is a schematic diagram illustrating the border between an edgewise bending portion and a non-bending portion;

FIG. 3A is a schematic diagram illustrating part of a bus bar according to Embodiment 2 of the present disclosure;

FIG. 3B is a cross-sectional view taken along the line X-X in FIG. 3A;

FIG. 4 is a schematic diagram illustrating an edgewise bending portion of a bus bar;

FIG. 5 is a schematic diagram illustrating part of a bus bar according to Embodiment 3 of the present disclosure;

FIG. 6 is a schematic diagram illustrating part of a bus bar according to Embodiment 4 of the present disclosure;

FIG. 7 is a schematic diagram illustrating part of a bus bar according to Embodiment 5 of the present disclosure; and

FIG. 8 is a schematic diagram illustrating part of a bus bar according to Embodiment 6 of the present disclosure.

### DETAILED DESCRIPTION

### Embodiment 1

In the present embodiment, edgewise bending is carried out, and flatwise bending may be carried out if necessary, to produce an aluminum alloy bus bar. The edgewise bending is bending, by a predetermined angle, a conductor of an aluminum alloy (including pure aluminum) rectangular wire (hereinafter called a rectangular conductor) by applying a bending load from the outer periphery side to the inner periphery side, where the inner periphery is a face on one shorter side and the outer periphery is another face on the other shorter side of the rectangular conductor. In contrast, the flatwise bending is bending, by a predetermined angle, an aluminum alloy rectangular conductor by applying a bending load from the outer periphery side to the inner periphery side, where the inner periphery is a face on one longer side and the outer periphery is another face on the other longer side of the rectangular conductor.

The following describes a preferred mode of a method for producing an aluminum alloy bus bar according to the present embodiment.

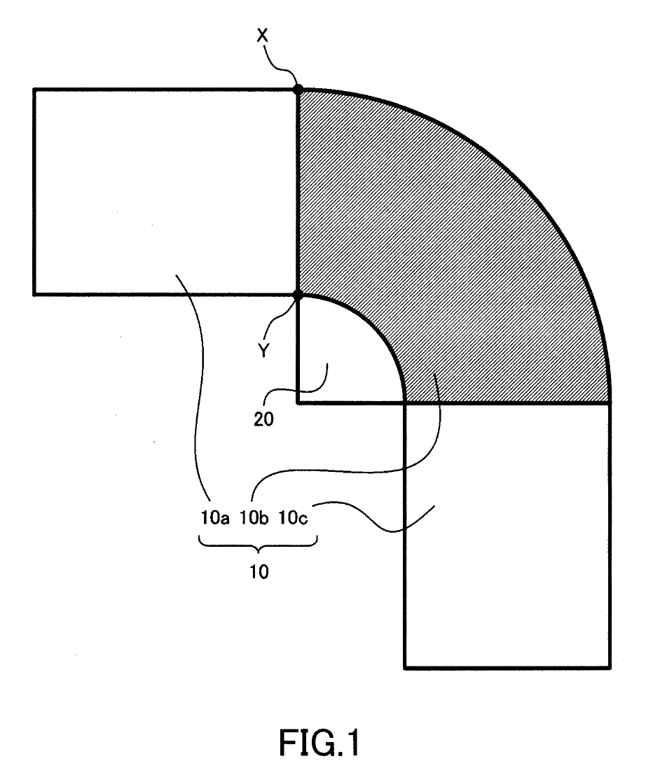

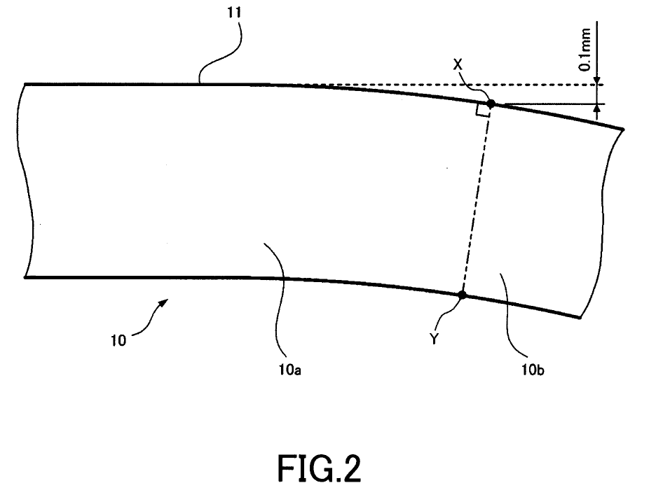

FIG. 1 shows a schematic diagram of an aluminum alloy bus bar that underwent edgewise bending. FIG. 2 shows a schematic diagram illustrating the border between an edgewise bending portion and a non-bending portion.

An aluminum alloy bus bar 10 is formed from an original rectangular conductor plate into a bus bar that includes a non-bending portion 10a, an edgewise bending portion 10b, and a non-bending portion 10c, through edgewise bending carried out with a die 20, as illustrated in FIG. 1. The non-bending portions 10a and 10c are substantially straight portions. The edgewise bending portion 10b is the shaded area in the figure. Before edgewise bending is carried out, the region corresponding to the edgewise bending portion 10b is heated. The region in an original plate corresponding to the edgewise bending portion 10b can be identified before edgewise bending by, for example, experimentally carrying out the edgewise bending in advance.

As illustrated in FIG. 2, the border between the edgewise bending portion 10b and the non-bending portion 10a is defined on the basis of a reference plane 11 of the non-bending portion 10a. Specifically, with reference to the figure, the border on one face is determined by the position of point X, which is on the outer periphery of an edgewise bending portion displaced by 0.1 mm from a virtual straight dashed line extended from the reference plane 11. The border on the other face is determined by the position of point Y, at which the face on the inner periphery intersects with a virtual chain double-dashed line that is extended from point X in the plate width direction and is substantially perpendicular to the outer periphery.

FIG. 2 illustrates definition of the border by using the relationship between the non-bending portion 10a and the edgewise bending portion 10b. The same definition is given by using the relationship between the non-bending portion 10c and the edgewise bending portion 10b. The edgewise bending described below includes heating at least the whole of the edgewise bending portion 10b in the aluminum alloy bus bar 10 to a predetermined temperature.

The following describes conditions for a method for producing the aluminum alloy bus bar according to the present embodiment.

Temperature at Edgewise Bending Portion: 100 to 250° C.

A higher temperature at the edgewise bending portion produces a better effect of improving bending workability. However, an excessively high temperature tends to cause acicular particles made of Mg and Si to be coarser to reduce the strength.

Setting the temperature at the edgewise bending portion to 100 to 250° C. can improve the edgewise bending workability while maintaining the strength of the material. When the temperature at the edgewise bending portion is lower than 100° C., the effect of improving the edgewise bending workability may be insufficient, and cracks or other problems may occur during the bending. When the temperature at the edgewise bending portion exceeds 250° C., acicular particles become coarser as described above, failing to achieve the product strength that a bus bar needs to have.

Edgewise Bending Carried Out within 5 Min. After Heating

After heated, the edgewise bending portion gradually loses its strength over time as acicular particles made of Mg and Si become coarser. When the material is held at a high temperature for 5 minutes or longer, the product strength needed for a bus bar is lost because such acicular particles become coarser. In the present embodiment, the heating temperature is limited to the aforementioned range and the edgewise bending is completed within 5 minutes after heating. This effectively prevents the material from losing its strength caused by over-aging of the material.

Mg: 0.3 to 0.9%

With Si coexisting, Mg (magnesium) has the effect of precipitating acicular particles to improve the strength of an aluminum alloy plate through precipitation strengthening. Since acicular particles impair bending workability, excessively precipitated acicular particles tend to weaken the bending workability.

The Mg content is set to 0.3 to 0.9%, which can improve the strength properties and bending workability of an aluminum alloy plate. From the same point of view, the Mg content is preferably set to 0.35 to 0.85%. When the Mg content is less than 0.3%, very few acicular particles are present and thus the strength of an aluminum alloy plate is reduced. When the Mg content exceeds 0.9%, too many acicular particles are present, and thus the bending workability is impaired, and cracks are highly likely to occur in an aluminum alloy plate.

Si: 0.2 to 1.2%

With Mg coexisting, Si (silicon) has the effect of precipitating acicular particles to improve the strength of an aluminum alloy plate. The Si content is set to a range of 0.2 to 1.2%, which can improve the strength properties and bending workability of an aluminum alloy plate. From the same point of view, the Si content is preferably set to 0.25 to 1.1%.

When the Si content is less than 0.2%, very few acicular particles are present and thus the strength of an aluminum alloy plate is reduced. When the Si content exceeds 1.2%, too many acicular particles are present, and thus the bending workability is impaired, and cracks are highly likely to occur in an aluminum alloy plate.

Cu: 0.2% or less

Depending on the type of an employed material, Cu (copper) can possibly be mixed into the material to some extent. Cu has the effect of facilitating formation of a shear band during bending. When a shear band is present, a tiny crack occurring during the bending is highly likely to spread through the shear band to develop cracks in an aluminum alloy plate. Thus, an excessively high Cu content may impair bending workability. Hence, the Cu content is limited to 0.2% or less, which can avoid the aforementioned problem and improve bending workability of an aluminum alloy plate. From the same point of view, the Cu content is preferably set to 0.1% or less.

Fe: 0.5% or less

Depending on the type of an advanced material, Fe (iron) can possibly be mixed into the material to some extent like Cu. When a larger amount of Fe is contained, Fe-based coarse particles are more likely to be generated in the Al matrix. Fe-based coarse particles can be an origin of cracks. Thus, an excessively high Fe content may impair bending workability and tends to cause cracks in an aluminum alloy plate. Hence, the Fe content is limited to 0.5% or less, which can avoid the aforementioned problem and improve bending workability of an aluminum alloy plate. From the same point of view, the Fe content is preferably set to 0.4% or less.

T6 Thermal Refining

Since 6000 series alloys used as bus bars need to have appropriate strength and electrical conductivity, T6 thermal refined aluminum alloy materials are suitably used.

Bending Speed: 90°/Sec or Less

When an aluminum alloy is bent at a high temperature, the workability depends on the bending speed. An edgewise bending speed exceeding 90°/second may reduce the effect of improving the bending workability and tends to cause cracks during the bending.

Portion to be Fastened to Another Component: 150° C. or Lower

When an aluminum alloy is held at a high temperature, an oxide film grows on the surface. A bolt may be fastened to connect the bus bar to another component, in which case, a thicker oxide film on the bus bar may cause a higher contact resistance in the fastening portion, leading to voltage loss or heating. When a portion to be fastened is at a temperature higher than 150° C., a thicker oxide film may be formed to cause a higher contact resistance in the material used as a bus bar. In other words, the portion to be fastened may be at a temperature higher than 150° C. as long as the contact resistance falls within an appropriate range. However, the temperature is preferably 150° C. or lower because the contact resistance can be easily reduced.

Hardness in Heated Portion: At Least 80% of Non-Heated Portion

A bus bar needs to have high strength. Thus, if the strength in a heated portion is reduced to 80% or less of the strength of a non-heated portion as a result of heating during the edgewise bending, the material is not suitable for use as a bus bar. The present embodiment employs hardness levels, which provide an easy way to make comparison among portions and are used as indicators of the strength. Appropriate control of the heating temperature and holding time ensures that hardness of a heated portion is at least 80% of that of a non-heated portion, thereby achieving the strength needed for bus bars.

To produce the bus bar of the present embodiment, flatwise bending may be carried out if necessary, in addition to the above-described edgewise bending.

### Embodiment 2

In the individual embodiments described below, other examples of edgewise bending carried out on an aluminum alloy bus bar are described. The aluminum alloy bus bars according to these embodiments have the conductive performance needed for bus bars and provide high product yields owing to the edgewise bending.

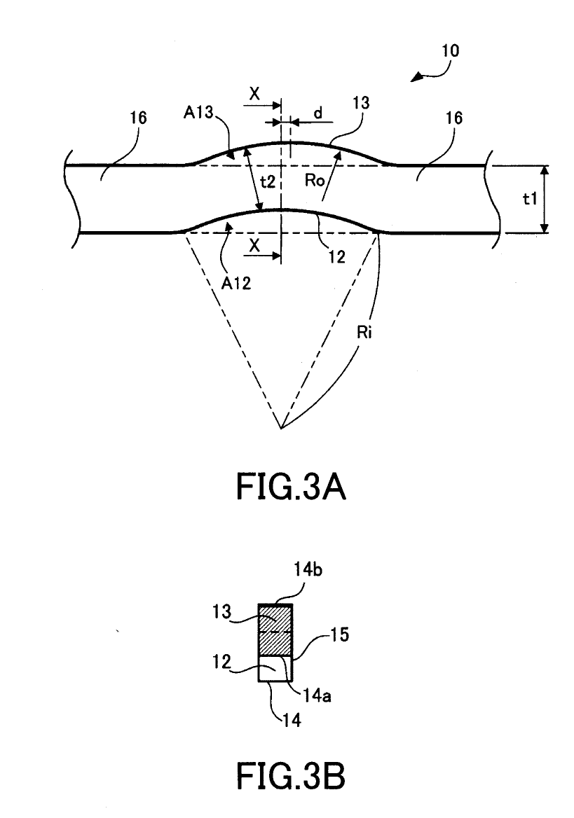

As illustrated in FIGS. 3A and 3B, an aluminum alloy bus bar 10 according to Embodiment 2 is basically formed into a rectangular bar defined by a straight portion 16, with the exception that at least one predetermined portion is curved, as seen in the figure, with an arc-shaped recess 12 and an arc-shaped projection 13 disposed in the portion in advance.

The aluminum alloy bus bar 10 is produced by blanking an aluminum alloy rolled plate to form the shape illustrated in FIG. 3A. Since aluminum alloys used as bus bars need to have appropriate strength, electrical conductivity, and bending workability, 1000 or 6000 series aluminum alloys, among others, are suitably used.

The recess 12 and the projection 13 each are formed by turning a shorter side face 14 in a rectangular cross section of the aluminum alloy bus bar 10 into either a recess (14a) or a projection (14b). Thus, FIG. 3A shows a longer side face 15 in a rectangular cross section.

The border between the straight portion 16 and the arc portion (the recess 12 or projection 13) is smoothly rounded. The border may be shaped with a gentler gradient than in FIG. 3. The same applies to structures described in a third and subsequent embodiments, where illustrations are partially simplified.

The recess 12 is formed to have a predetermined radius Ri. The projection 13 is formed to have a radius Ro, which is equal to that of the recess 12 or is defined taking into consideration the shape of the aluminum alloy bus bar 10 subjected to the edgewise bending described below. The center of the projection 13 is shifted to the right by a distance d from the center of the recess 12, as illustrated in the figure. Shifting the centers from each other in this way makes it easier to carry out the edgewise bending to obtain a desired shape.

Depending on dimensions of the aluminum alloy bus bar 10 or on the employed edgewise bending method, the centers may be shifted in a direction opposite to the example in FIG. 3.

As described below, the inner side of edgewise bending will be finally arc-shaped. Thus, an arc shape is preferably made in advance in view of formability.

Now, letting t1 be the plate width in the straight portion 16, and t2 be the width (a minimum distance between edges of the recess 12 and projection 13) of the edgewise bending portion, which is a curved portion formed by the recess 12 and projection 13, preferably t2 t1 is satisfied. This should be satisfied because the aluminum alloy bus bar 10 is used as an electrically conductive member and needs to have the required conductivity.

Suppose that virtual lines are drawn in FIG. 3 to indicate both edges of the straight portion 16 with respect to a width direction in the edgewise bending portion. Letting A12 be the area of the recess region formed between the recess 12 and the virtual straight line, and A13 be the area of the projection region formed between the projection 13 and the virtual straight line, A13 is preferably equal to or greater than A12. This should be satisfied because, in order to have sufficient cross-sectional areas throughout the bending portion after bending, the area of the projection needs to be equal to or larger than that of the recess. More preferably, the area of the projection 13 is larger than the recess 12 (A13>A12).

In addition, the perimeter of the arc of the projection 13 is preferably longer than the perimeter of the arc of the recess 12. During the edgewise bending, the outer periphery of a bending portion extends while the inner periphery of the bending portion shrinks. Such extension and shrinkage can be reduced by disposing the projection 13 and the recess 12. To prevent the edgewise bending from causing cross-sectional areas in the conductor to be reduced, the projection 13 and the recess 12 are formed in advance so that the projection 13 has a longer perimeter than the recess 12.

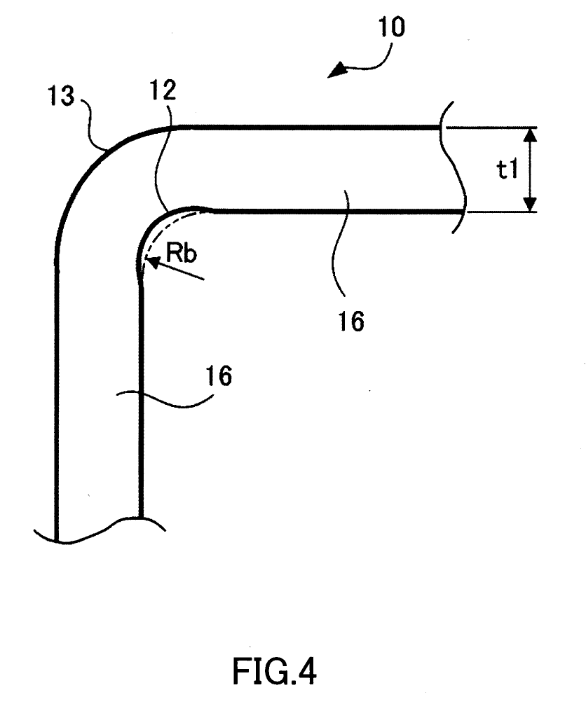

The following describes a bending form of the foregoing aluminum alloy bus bar 10 referring to FIG. 4.

In the present embodiment, edgewise bending is carried out on the aluminum alloy bus bar 10. The edgewise bending is bending, by a predetermined angle, a rectangular conductor of an aluminum alloy (including pure aluminum) by applying a bending load from the outer periphery side to the inner periphery side, where the inner periphery is a face on one shorter side and the outer periphery is another face on the other shorter side of the rectangular conductor. In contrast, the flatwise bending is bending, by a predetermined angle, an aluminum alloy rectangular conductor by applying a bending load from the outer periphery side to the inner periphery side, where the inner periphery is a face on one longer side and the outer periphery is another face on the other longer side of the rectangular conductor.

With reference to the example in FIG. 4, the aluminum alloy bus bar 10 is bent by 90°, where the recess 12 is on the inner periphery and the projection 13 is on the outer periphery. The chain double-dashed line in the figure indicates an inner bending radius Rb that a simple rectangular conductor would have. Assuming that Rb is formed in an arc shape starting from the border between the straight portion 16 and the recess 12, Rb can be determined on the basis of the size of the recess 12 and the angle between straight portions 16 on both sides of the recess 12.

The bending causes the recess 12 to be shrunk and deformed to have a smaller inner diameter, but the inner diameter is equal to or somewhat larger relative to the inner bending radius Rb. The projection 13 suffers a pull force caused by the bending. In the example in FIG. 4, an outer diameter of the projection 13 before the bending is determined so as to prevent the projection 13 from sticking out during the bending.

As described above, the aluminum alloy bus bar 10 according to the present embodiment includes the recess 12, which is disposed on the inner periphery of an edgewise bending portion before the edgewise bending is carried out. This produces the effect of reducing strain to be generated on the outer periphery of a bending portion.

In addition, the projection 13 is disposed on the outer periphery of an edgewise bending portion before the edgewise bending is carried out. This produces the effect of compensating for a loss of cross-sectional areas caused by formation of the recess 12, and thus required conductivity can be obtained.

The aluminum alloy bus bar 10 needs to have a greater width for assuring conductivity, and also needs to have a smaller inner bending radius Rb for containing itself in a small space. Accordingly, in order to form a material into the bus bar having an inner bending radius Rb smaller than the plate width t1 without causing cracks, the recess 12 and the projection 13 are preferably formed. For example, even if edgewise bending would cause cracks or constriction on the outer periphery of a bending portion of a simple rectangular conductor with Rb/t1 being equal to approximately 1, Rb/t1 can be made smaller by forming the the recess 12 and the projection 13.

According to the present embodiment, the recess 12 and the projection 13 are disposed only in part of the substantially straight portion 16 where edgewise bending is to be carried out. As a result, the present embodiment can improve yields in producing the aluminum alloy bus bar 10, compared with the case where a plate material is blanked into a shape corresponding to the shape obtained by the edgewise bending.

### Embodiment 3

As in the Embodiment 2, an aluminum alloy bus bar 10 according to Embodiment 3 includes a recess 12 and a projection 13 disposed in an edgewise bending portion. The difference from the Embodiment 2 is that the center of the recess 12 (valley) is aligned with the center of the projection 13 (mountain).

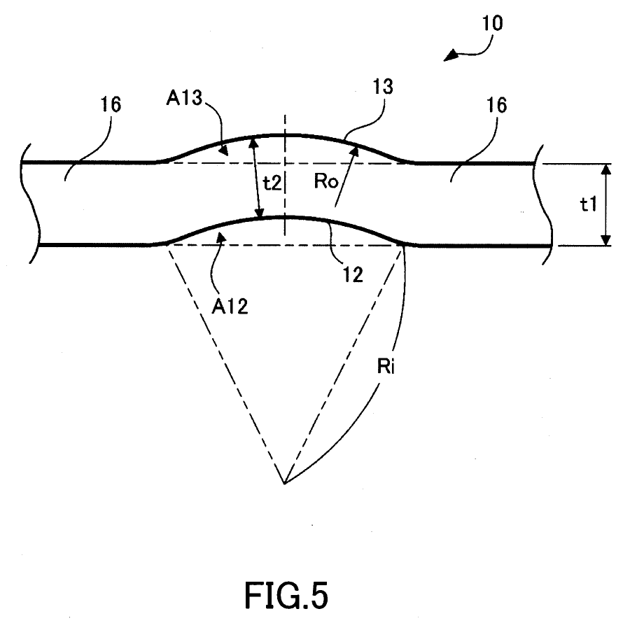

As illustrated in FIG. 5, the center of the projection 13 is aligned with the center of the recess 12 with respect to a horizontal direction in the figure. In this way, in addition to the Embodiment 2, the center of the recess 12 may be placed at any position in relation to the center of the projection 13, depending on the plate width t1, the inner bending radius Rb, and other dimensions of the aluminum alloy bus bar 10, and on the employed edgewise bending method.

### Embodiment 4

The following describes examples of the shape of the projection 13 according to Embodiment 4 to Embodiment 6.

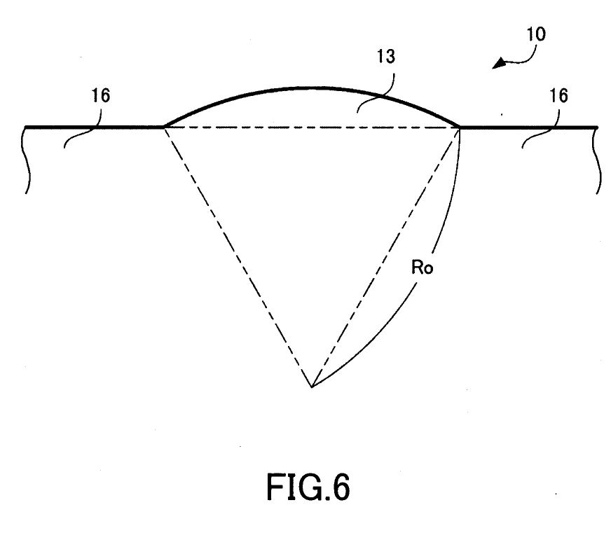

In the Embodiment 4 illustrated in FIG. 6, a single projection 13 having a radius Ro is disposed. The recess 12, which is omitted in the figure, is formed in the same way as in FIG. 3. The outer diameter of the projection 13 in FIG. 6 may not necessarily be identical to the inner diameter of the recess 12 in FIG. 3. Accordingly, the example in FIG. 6 is equivalent to the configuration illustrated in FIG. 3.

### Embodiment 5

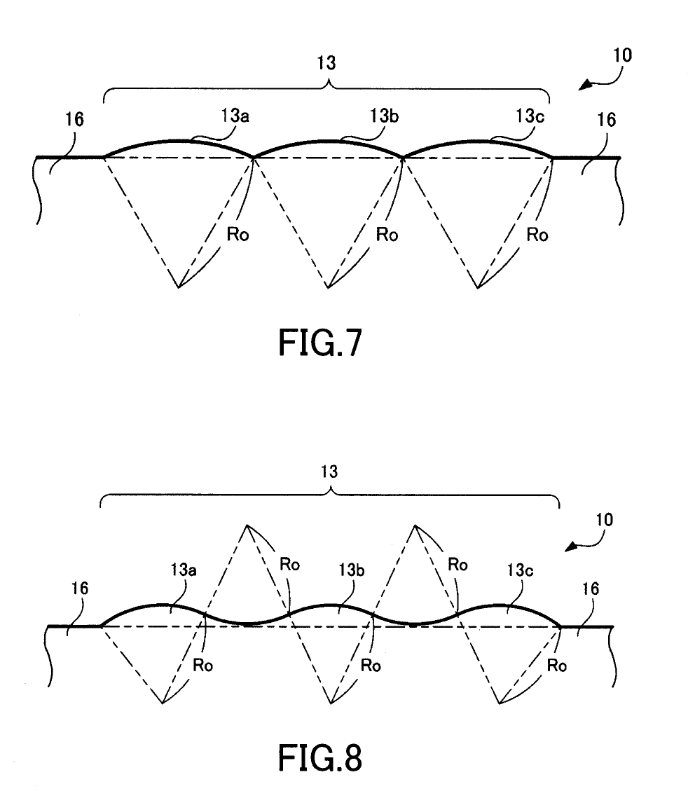

In the Embodiment 5 illustrated in FIG. 7, individual projections 13a, 13b, and 13c having a radius Ro are arranged to form the projection 13. The recess 12, which is omitted in the figure, is formed in the same way as in FIG. 3. The outer diameter of the individual projections 13a, 13b, and 13c in FIG. 6 may not necessarily be identical to the inner diameter of the recess 12 in FIG. 3, and the recess 12 is formed so that its width is approximately equal to the width of the illustrated projection 13. Since the ends of an arc in the projection 13 tend to suffer intensive deformation, arranging a plurality of arcs as in the present embodiment can disperse deformation.

### Embodiment 6

In the Embodiment 6 illustrated in FIG. 8, individual projections 13a, 13b, and 13c are arranged to form the projection 13 as in FIG. 7. The difference between the present embodiment and FIG. 7 is that the individual projections 13a, 13b, and 13c have a radius Ro not only on their mountain side but also on the valley side between the individual projections 13a and 13b and between 13b and 13c. As a result, a waveform like a substantially sine wave is formed in the individual projections 13a through 13c. The configuration illustrated in FIG. 8 can also disperse deformation by arranging a plurality of arcs as in FIG. 7. In addition, this effect is enhanced by further arranging arcs on the valley side as described above.

It should be noted that the present disclosure is not limited to the above-described embodiments and examples and allows for various variations and applications.

The inner bending radius Rb of an edgewise bending portion may be smaller than the width t1 (width of a longer side face 15) of a cross section of the rectangular conductor. As the inner bending radius Rb is smaller relative to the width t1 of a cross section of the rectangular conductor, cracks are more likely to occur during the edgewise bending, and thus the effect produced by forming the recess 12 is more noticeable.

The recess 12 may be in an arc shape having a radius equal to or greater than the inner bending radius Rb of an edgewise bending portion. The inner periphery of a bending portion is subjected to compression and deformation in a longitudinal direction during the edgewise bending. Thus, forming an arc shape having a radius equal to or greater than the inner bending radius Rb in advance results in forming a shape equivalent to the inner bending radius Rb after the edgewise bending.

### EXAMPLES

Examples of a method for producing the aluminum alloy bus bar illustrated in Embodiment 1 will now be described along with comparative examples that are out of the scope of the present disclosure. For these examples, aluminum alloy plates each containing alloy components listed in Table 1 were prepared, and edgewise bending was carried out under conditions shown in Table 1 to obtain test materials 1 to 27. Chemical components include the elements listed in Table 1, with a balance consisting of Al and inevitable impurities. The individual test materials were evaluated in terms of hardness, edgewise bending workability, and contact resistance.

TABLE 1

| | | | | | Conditions for edgewise bending | | | | | |
|---|---|---|---|---|---|---|---|---|---|---|
| | | | | | | | | | | Fastening |
| | Chemical components | | | | Plate | Plate | Heating | Holding | Bending | portion |
| | (mass %) | | | | thickness | width | temp. | time | speed | temp. |
| No. | Mg | Si | Cu | Fe | (mm) | (mm) | (° C.) | (min.) | (°/s) | (° C.) |
| Test material 1 | 0.55 | 0.66 | 0.10 | 0.31 | 2.0 | 30 | 200 | 3 | 30 | 118 |
| Test material 2 | 0.85 | 0.67 | 0.09 | 0.27 | 2.0 | 30 | 200 | 3 | 30 | 115 |
| Test material 3 | 0.97 | 0.67 | 0.09 | 0.27 | 2.0 | 30 | 200 | 3 | 30 | 108 |
| Test material 4 | 0.35 | 0.70 | 0.12 | 0.28 | 2.0 | 30 | 200 | 3 | 30 | 108 |
| Test material 5 | 0.20 | 0.58 | 0.12 | 0.31 | 2.0 | 30 | 200 | 3 | 30 | 113 |
| Test material 6 | 0.57 | 1.14 | 0.09 | 0.35 | 2.0 | 30 | 200 | 3 | 30 | 121 |
| Test material 7 | 0.51 | 1.30 | 0.11 | 0.30 | 2.0 | 30 | 200 | 3 | 30 | 125 |
| Test material 8 | 0.60 | 0.24 | 0.11 | 0.28 | 2.0 | 30 | 200 | 3 | 30 | 127 |
| Test material 9 | 0.50 | 0.11 | 0.11 | 0.30 | 2.0 | 30 | 200 | 3 | 30 | 121 |
| Test material 10 | 0.58 | 0.70 | 0.18 | 0.30 | 2.0 | 30 | 200 | 3 | 30 | 112 |
| Test material 11 | 0.50 | 0.71 | 0.31 | 0.34 | 2.0 | 30 | 200 | 3 | 30 | 109 |
| Test material 12 | 0.53 | 0.65 | 0.11 | 0.46 | 2.0 | 30 | 200 | 3 | 30 | 104 |
| Test material 13 | 0.56 | 0.63 | 0.10 | 0.57 | 2.0 | 30 | 200 | 3 | 30 | 114 |
| Test material 14 | 0.55 | 0.66 | 0.10 | 0.31 | 2.0 | 30 | 100 | 3 | 30 | 84 |
| Test material 15 | 0.55 | 0.66 | 0.10 | 0.31 | 2.0 | 30 | 250 | 3 | 30 | 135 |
| Test material 16 | 0.55 | 0.66 | 0.10 | 0.31 | 2.0 | 30 | 200 | 5 | 30 | 123 |
| Test material 17 | 0.55 | 0.66 | 0.10 | 0.31 | 2.0 | 30 | 200 | 3 | 90 | 128 |
| Test material 18 | 0.55 | 0.66 | 0.10 | 0.31 | 2.0 | 30 | 200 | 3 | 120 | 116 |
| Test material 19 | 0.55 | 0.66 | 0.10 | 0.31 | 2.0 | 30 | 200 | 3 | 30 | 143 |
| Test material 20 | 0.55 | 0.66 | 0.10 | 0.31 | 2.0 | 30 | 200 | 3 | 30 | 171 |
| Test material 21 | 0.55 | 0.66 | 0.10 | 0.31 | 4.0 | 30 | 200 | 3 | 30 | 121 |
| Test material 22 | 0.55 | 0.66 | 0.10 | 0.31 | 1.0 | 30 | 200 | 3 | 30 | 109 |
| Test material 23 | 0.55 | 0.66 | 0.10 | 0.31 | 2.0 | 40 | 200 | 3 | 30 | 111 |
| Test material 24 | 0.55 | 0.66 | 0.10 | 0.31 | 2.0 | 20 | 200 | 3 | 30 | 120 |
| Test material 25 | 0.55 | 0.66 | 0.10 | 0.31 | 2.0 | 30 | 80 | 3 | 30 | 65 |
| Test material 26 | 0.55 | 0.66 | 0.10 | 0.31 | 2.0 | 30 | 270 | 3 | 30 | 145 |
| Test material 27 | 0.55 | 0.66 | 0.10 | 0.31 | 2.0 | 30 | 200 | 7 | 30 | 130 |

Test materials were prepared by following the steps described below. First, ingots were produced through DC casting, each being 500 mm thick and 500 mm wide in size and containing the chemical components listed in Table 1. The obtained ingot was heated at 550° C. for 12 hours to be homogenized, and then hot rolled into a 6.0 mm thick roughly rolled plate. The ingot was at 550° C. when the heat rolling was started. The roughly rolled plate was at 350° C. when the hot rolling was finished. Then, the roughly rolled plate was cold rolled into a plate material having a thickness of 1.0 to 4.0 mm. For use as bus bars, aluminum alloy plates having a thickness of 1.0 to 4.0 mm are suitably used.

Next, the plate material was heated and subjected to solution treatment. During the solution treatment, the plate material was heated up to 550° C., and then held for one minute. Following the solution treatment, the plate material was heated and subjected to artificial aging treatment. During the artificial aging treatment, the plate material was heated up to 170° C., and then held for 8 hours. The resulting plate material was cut into a piece 20 to 30 mm wide and 300 mm long. To produce a bus bar through edgewise bending, a plate having a width of about 20 to 40 mm is suitably used in view of assuring appropriate edgewise bending workability and conductivity.

Next, edgewise bending was carried out on the plate material that has been cut out. Steps of the edgewise bending were as follows. First, the portion of the plate material to be bent was held between blocks heated at a heating temperature shown in Table 1 to heat the plate material. After heated to the heating temperature, the plate material was held at high temperature for a holding time shown in Table 1. Next, edgewise bending by 90° was carried out with an inner bending radius of 15 mm and a bending speed shown in Table 1 to obtain test materials 1 to 23. The shape illustrated in FIG. 1, which is described above, is the resulting shape of the edgewise bending.

With the resulting test materials 1 to 23, hardness tests, evaluations of edgewise bending workability, and contact resistance measurements were conducted. Details of the individual tests are described below.

(Hardness Test)

The Vickers hardness test was conducted according to the test method specified in JIS Z 2244 to measure Vickers hardness of heated and non-heated portions of each test material. The test was conducted with a load of 10 kgf (HV 10). From the hardness A of a non-heat portion and the hardness B of a heated portion, a test material was evaluated as acceptable in the hardness test when the hardness of the non-heated portion was 50 or higher (more preferably, 55 or higher) and the ratio A/B of the hardness A of the heated portion to the hardness B of the non-heated portion was 0.8 or higher.

(Evaluation of Edgewise Bending Workability)

Evaluation of edgewise bending workability was conducted by visually determining whether any constriction or crack had occurred in the edgewise bending portion. The workability was evaluated as one of three grades: No Constriction (good)>Constriction>Crack (bad). In the evaluation of edgewise bending workability, a test material with either No Constriction or Constricted was evaluated as acceptable.

(Evaluation of Contact Resistance)

For evaluating contact resistance, 2 plates, 20 mm wide and 40 mm long each, were cut out from a non edgewise bending portion in each test material. A hole having a 6 mm diameter was made at the center of each plate with a drill press, and an M6 bolt was tighten on the plates with a tightening torque of 5 N·m to make a bolted joint. The resistance between two plates was measured by using the four-terminal sensing method. In the evaluation of contact resistance, a test material having a resistance level of 100 μΩ or less (more preferably, 50 μΩ or less) was evaluated as acceptable.

Table 2 shows results of the evaluations described above.

TABLE 2

| | Hardness | | | | | |
|---|---|---|---|---|---|---|
| | Hardness | Hardness in | | | | |
| | in heated | non-heated | | | Contact | |
| | portion: A | portion: B | | Result of | resistance | |
| No. | (HV10) | (HV10) | A/B | bending | (μΩ) | Remarks |
| Test material 1 | 54 | 59 | 0.91 | No Constriction | 32 | Example |
| Test material 2 | 56 | 61 | 0.91 | No Constriction | 30 | Example |
| Test material 3 | 57 | 64 | 0.90 | Constriction | 36 | Example |
| Test material 4 | 52 | 57 | 0.91 | No Constriction | 31 | Example |
| Test material 5 | 51 | 54 | 0.94 | No Constriction | 34 | Example |
| Test material 6 | 56 | 62 | 0.91 | No Constriction | 39 | Example |
| Test material 7 | 56 | 65 | 0.87 | Constriction | 36 | Example |
| Test material 8 | 52 | 56 | 0.93 | No Constriction | 37 | Example |
| Test material 9 | 50 | 53 | 0.94 | No Constriction | 30 | Example |
| Test material 10 | 55 | 59 | 0.92 | No Constriction | 28 | Example |
| Test material 11 | 56 | 60 | 0.94 | Constriction | 31 | Example |
| Test material 12 | 54 | 59 | 0.92 | No Constriction | 29 | Example |
| Test material 13 | 54 | 58 | 0.93 | Constriction | 30 | Example |
| Test material 14 | 57 | 59 | 0.97 | No Constriction | 25 | Example |
| Test material 15 | 52 | 59 | 0.89 | Constriction | 41 | Example |
| Test material 16 | 51 | 59 | 0.86 | No Constriction | 33 | Example |
| Test material 17 | 54 | 59 | 0.91 | No Constriction | 34 | Example |
| Test material 18 | 55 | 59 | 0.94 | Constriction | 34 | Example |
| Test material 19 | 54 | 59 | 0.92 | No Constriction | 45 | Example |
| Test material 20 | 53 | 59 | 0.89 | No Constriction | 64 | Example |
| Test material 21 | 55 | 60 | 0.92 | No Constriction | 26 | Example |
| Test material 22 | 54 | 59 | 0.92 | No Constriction | 36 | Example |
| Test material 23 | 54 | 59 | 0.92 | No Constriction | 31 | Example |
| Test material 24 | 54 | 59 | 0.92 | No Constriction | 27 | Example |
| Test material 25 | 57 | 59 | 0.97 | Crack | 29 | Comparative |
| | | | | | | Example |
| Test material 26 | 45 | 59 | 0.77 | No Constriction | 43 | Comparative |
| | | | | | | Example |
| Test material 27 | 46 | 59 | 0.78 | No Constriction | 38 | Comparative |
| | | | | | | Example |

As seen in Tables 1 and 2, the test materials 1 to 24, which represent Examples, were edgewise-bent by using the specific edgewise bending method described above. As a result, the test materials 1 to 24 exhibited superior strength, edgewise bending workability, and contact resistance. The test materials 1 to 24 satisfied the properties needed for bus bars and were suitable as materials for bus bars.

The test material 25 was evaluated as unacceptable in the evaluation of edgewise bending workability because the effect of improving the edgewise bending workability was not enough, which was attributable to the low heating temperature at which the edgewise bending was carried out.

The test material 26 was evaluated as unacceptable in the hardness test on a heated portion because the strength was reduced by acicular particles that became coarser, which was attributable to the high heating temperature at which the edgewise bending was carried out.

The test material 27 was evaluated as unacceptable in the hardness test on a heated portion because the strength was reduced by acicular particles that became coarser, which was attributable to the long holding time during the edgewise bending.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of. Japanese Patent Application No. 2016-204723 filed on Oct. 18, 2016, and Japanese Patent Application No. 2017-112439 filed on Jun. 7, 2017, of which the entirety of the disclosures is incorporated by reference herein.
10 Aluminum alloy bus bar
10a, 10c Non-bending portion
10b Edgewise bending portion
11 Reference plane
12 Recess
13 Projection
13a, 13b, 13c Individual projection
14 Shorter side face
14a Recess
14b Projection
15 Longer side face
16 Straight portion
20 Die

What is claimed is:

1. An aluminum alloy material for a bus bar, wherein the material comprises a straight portion and edgewise bending is to be carried out on the material, the material comprising:
a recess formed in a portion corresponding to inner periphery of a bending portion for the edgewise bending; and
a projection formed in a portion corresponding to outer periphery of a bending portion for the edgewise bending.

2. The aluminum alloy material for a bus bar according to claim 1,
wherein the recess is in an arc shape having a radius at least equal to an inner bending radius of an edgewise bending portion, and
wherein a minimum distance between an edge of the recess and an edge of the projection is at least equal to a width of the straight portion.

3. The aluminum alloy material for a bus bar according to claim 1,
wherein an area of the projection is at least equal to an area of the recess.

4. The aluminum alloy material for a bus bar according to claim 1,
wherein the projection comprises a plurality of individual projections.

5. The aluminum alloy material for a bus bar according to claim 1,
wherein perimeter of an arc of the projection is longer than perimeter of an arc of the recess.

6. An aluminum alloy bus bar comprising:
the aluminum alloy material for a bus bar according to claim 1.
